(19) United States
(12) Patent Application Publication
(10) Pub. No.: US 2003/0018657 A1
(43) Pub. Date: Jan. 23, 2003

(54) Backup of data on a network

(75) Inventor: Paul B. Monday, Rochester, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 09/908,172

(22) Filed: Jul. 18, 2001

(51) Int. Cl. G06F 7/00

(52) U.S. Cl. 707/204

(57) ABSTRACT

Backup of network data is facilitated by using a native file sharing protocol to access shared data from a network device. Using a native file sharing protocol allows the data to be backed up from the network device without installing client software on the network device and without significantly modifying the network device. As a result, backup capabilities are available to a wide variety of network devices, including, for example, NAS and other devices that are not amenable to installation of client software.

### TECHNICAL FIELD

The invention relates to information storage and, more particularly, to backing up data on computer networks.

### BACKGROUND

Many computer networks employ data backup schemes to protect against loss of data due to a variety of causes including human error, computer viruses, and other unfortunate events. Such data backup schemes typically use a client-server architecture to back up data from a networked client computer to a file server, such as a Network Attached Storage (NAS) server.

Conventional backup systems typically utilize a hardware backup device executing server software. These backup devices are typically placed within a network of client computers executing client software. The client computers use the client software to communicate with the server software via a variety of network protocols, e.g., Internet Protocol (IP). The client-server architecture is conventionally implemented using one of two models: a client-oriented “push” model and a server-oriented “pull” model.

In the client-oriented “push” model, also known as a synchronization model, the client software detects changes in data residing on the client computer and pushes the changed data to the remote backup device, for example, a file server. A system administrator may then back this data up to secondary media, such as a tape backup device, using a secondary backup program. Because the client computer uses the client software to push or synchronize changed data to the remote backup device, the client software is required for the backup process. Another limitation of the synchronization model is a lack of central management of the backup process. If several client computers are present on the network, each one backs up data independently. As a result, contention problems may arise when multiple client computers attempt to back up data simultaneously.

The server-oriented “pull” model is strongly centralized and may be characterized by heavy client installation and manageability from the server software. In this model, the server software is installed on a machine, such as a file server, and is actively involved in retrieving data from the client computers. The server software bypasses the conventional file services of the operating system. As with the client-oriented “push” model, the server-oriented “pull” model also requires the client computers to execute client software. The server software communicates with the client software to retrieve the data to be backed up. In addition, the client computers may use the client software to push data to the server, as in the client-oriented “push” model.

As described above, both the client-oriented “push” model and the server-oriented “pull” model involve installation of client software on the network devices that have data to be backed up. Accordingly, a network device that has data to be backed up but for some reason cannot readily execute the client software cannot easily participate in the backup process. Conventional NAS devices, for example, do not typically have a user-accessible operating system and, therefore, a system administrator is often unable to install the client software. Other network devices that may be unable to readily participate in the backup process include devices that exhibit nonstandard installation scenarios, e.g., devices with directory structures that differ from an expected structure. As a particular example, it may be difficult to install the client software on devices in which necessary files are located in non-typical directories.

### SUMMARY

In general, the invention facilitates backup of data from network devices by using a network file sharing protocol to receive data from a network device. The file sharing protocol is native to, i.e., integrated in, the operating system of the network device from which data is to be backed up, and allows multiple devices on a network to access data on the network. To backup data on the network, a network device uses the native file sharing protocol to share the data onto the network for other devices to view. A backup device uses the native file sharing protocol to query and browse the file system of the network device to locate the shared data. The backup device then backs the shared data up to local disk drives. As the local disk drives are populated with backup data, the backup device may archive data to a secondary device, such as a tape backup device.

One example of file sharing protocol is the Common Internet File System (CIFS) protocol, which is native to the MICROSOFT WINDOWS® operating system. The CIFS protocol incorporates multi-user read and write capabilities, as well as locking mechanisms to prevent conflicts. For example, in the context of the invention, these locking mechanisms are used to prevent a network device from modifying data while the data is being backed up.

Using a file sharing protocol native to the operating system of the network device provides centralized management capabilities without the need to install and execute client software on the network device and without modifying the network device significantly. As a result, backup capabilities are available to a wide variety of network devices, including, for example, NAS and other devices that are not amenable to installation of client software. Certain embodiments of the invention may involve storing the data using a pool of disk drives and archiving the data to a tape-based device.

One embodiment is directed to a network backup device comprising an interface module to receive a backup schedule from a user, a scheduling module to determine whether to back up data from shared storage areas of devices within a network based on the schedule, a set of data access modules to access data using file sharing protocols native to operating systems of the network devices, and a backup module to store the data to a storage medium.

One embodiment is directed to a backup device comprising a data sharing module to access data from a network device using a file sharing protocol native to an operating system of the network device. A storage medium backs up the accessed data.

In another embodiment, a backup arrangement includes a data sharing module to access data from a network device using a file sharing protocol native to an operating system of the network device. A plurality of disk drives back up the accessed data. A tape-based medium archives data from the plurality of disk drives.

Another embodiment is directed to a backup device that includes a scheduling module to initiate a backup operation according to a backup schedule and a backup module to access shared data from a device in communication with a network and to store the received data using an offline storage medium. In a specific implementation, the backup module accesses the shared data using a file sharing protocol native to an operating system of the device in communication with the network, such as the CIFS, NFS, or AppleTalk protocol.

A method for backing up data on a network may involve accessing data from a network device using a file sharing protocol native to an operating system of the network device and storing the accessed data using a storage medium.

A method for restoring data stored on a backup device connected to a network may involve outputting the data using a file sharing protocol native to an operating system of the backup device and storing the data using a network device connected to the network.

These methods may be implemented using computer-readable media.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a system diagram illustrating an example computer network including a network backup device, according to one embodiment of the invention.

FIG. 2 is a block diagram illustrating an example network backup device, according to another embodiment of the invention.

FIG. 3 is a flow diagram illustrating an example mode of operation for backing up data on a network, according to an embodiment of the invention.

### DETAILED DESCRIPTION

In general, the invention facilitates backup of data from network devices by using a native file sharing protocol to receive shared data from a network device. The file sharing protocol is native in that it is integrated in the operating system of the network device from which data is to be backed up. The native file sharing protocol allows multiple devices on a network to access data on the network. Using a native file sharing protocol provides centralized management capabilities without the need to install and execute client software on the network device and without modifying the network device significantly.

One example of file sharing protocol is the Common Internet File System (CIFS) protocol, which is native to the MICROSOFT WINDOWS® operating system. The CIFS protocol allows multiple users to read data from and write data to a device and provides locking mechanisms to prevent conflicts. For example, in the context of the invention, these locking mechanisms are used to prevent a network device from modifying data while the data is being backed up. Other file sharing protocols that may be used include the Network File System (NFS) protocol, native to the UNIX and Apple OS X operating systems, and the AppleTalk protocol, native to the MACINTOSH® operating system. Other types of systems may use different file sharing protocols native to, or bundled with, their respective operating systems, and the backup techniques described herein can be adapted for use with a variety of file sharing protocols, including but not limited to the specific file sharing protocols enumerated above.

To back up data on the network, a network device, such as a computer connected to the network, uses the native file sharing protocol to share the data onto the network for other devices to view. Because the network device originates the data to be backed up, it is referred to as the data source. A backup device browses the file system of the network device to locate the shared data using the native file sharing protocol. After it locates the shared data, the backup device backs the shared data up to local disk drives that are on board the backup device. As the local disk drives are populated with backup data, the backup device may archive data to a secondary device, such as a tape backup device. Unlike some other types of storage devices, the backup device is not visible on the network as a storage drive, and is not used for general storage purposes.

Using a native file sharing protocol allows the data to be backed up from a network device without the need to install client software on the network device and without the need to modify the network device in any significant way. As a result, backup capabilities are available to a wide variety of network devices, including, for example, NAS and other devices that are not amenable to installation of client software.

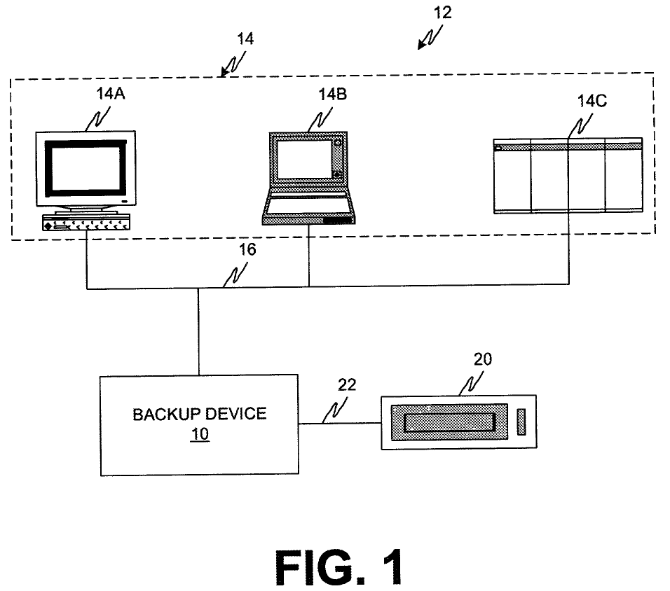

FIG. 1 is a system diagram illustrating the use of a network backup device 10 with an existing system 12 of client devices 14, depicted in FIG. 1 as computers connected to a network 16. Backup device 10 may be implemented as part of a rack-mounted system or as a stand-alone backup appliance. Both implementations may use similar hardware and software components. System 12 can include a variety of computers or other client devices 14 using different file sharing protocols, including, for example, a UNIX-based workstation 14A that uses the NFS protocol and a MICROSOFT WINDOWS®-based laptop computer 14B that uses the CIFS protocol. Client devices 14 may also include, for example, a networked file server having a shared storage area, such as a network attached storage (NAS) device 14C, which may also use the CIFS protocol. The client devices 14 and backup device 10 can be connected, for example, in a local area network (LAN), wide area network (WAN) or wireless local area network (WLAN).

Client devices 14 use their respective native file sharing protocols to share onto network 16 data that is to be backed up. For example, client devices 14 may share files or directories, or both, making these shared files or directories available to other devices connected to network 16, including backup device 10. These shared files or directories are collectively referred to as shares and may be accessed by transmitting requests from backup device 10 to client devices 14. When a client device 14 receives a request for a share, it transmits the share to the requesting device, namely, backup device 10.

After being connected to network 16 and initialized, backup device 10 can use the native file sharing protocol of each of the client devices 14 to query and browse its file system to find the shared data. For example, if data is to be backed up from laptop computer 14B, backup device 10 uses the CIFS protocol to find the shared data. Because the native file sharing protocols are built into the respective operating systems of client devices 14, no client software installation is required. Consequently, backup device 10 can back up data from the file systems of client devices 14 on, for example, one or more local disk drives (not shown in FIG. 1). Local disk drives are used for incremental backup operations, which may be scheduled on an hourly or daily basis, due to their speed and relative independence from operator intervention, e.g., exchanging media. RAID techniques may be used to provide enhanced security against data loss in the local disk drives. The number, size, and performance of the local disk drive or drives may vary based on the requirements of the particular application. For instance, some applications may require only 40 GB of backup space, while others may require 640 GB with greater reliability and data safekeeping capabilities.

While not required, backup device 10 can also archive data from local disk drives to a long-term backup device 20, such as a single tape drive or a tape autoloader, optical juke box or the like, connected to backup device 10 via a communication link 22, such as a SCSI connection. Archiving is useful, for example, for performing full backup operations on a weekly or monthly basis, or as needed. Long-term backup device 20 offers the advantage of using removable media, which can be stored off-site for use in disaster scenarios. Local disk-based storage for incremental backup operations substantially shrinks the full backup window and reduces operator intervention for backup to long-term backup device 20 or other secondary media.

Restoring data to a client device 14 involves applying one or more data snapshots that contain information that is used to reconstruct the backed up data on that client device 14. These data snapshots may include, for example, a snapshot of the data captured during a full backup operation and one or more additional snapshots captured during incremental backup operations that represent changes to the backed up data after the full backup operation. If data needs to be restored from network backup device 10, several data snapshots are directly available from network backup device 10. Data snapshots older than a tape cycle of tape-based backup device 20 can be restored from tape-based backup device 20. Such restore operations may involve some operator intervention.

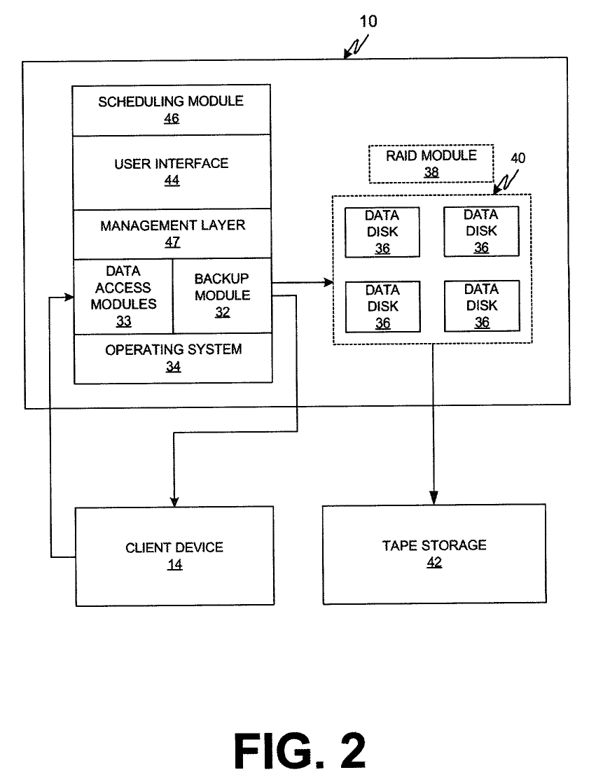

As described below in connection with FIG. 2, network backup device 10 uses software to implement the backup and restore capabilities. This software may be implemented in some form of computer-readable media, which may be included in network backup device 10. By way of example, and not limitation, computer-readable media may comprise computer storage media, communication media, or both. Computer storage media includes volatile and nonvolatile, removable and nonremovable media implemented in any method or technology for storage of information such as processor-readable instructions, data structures, program modules, or other data. For example, the various software modules illustrated in and described in connection with FIG. 2 may be stored in random access memory (RAM), read-only memory (ROM), EEPROM, flash memory, CD-ROM, digital versatile discs (DVD) or other optical storage, magnetic cassettes, magnetic tape, magnetic disk storage or other magnetic storage devices incorporated into or accessible by network backup device 10. Computer storage media also includes any other medium that can be used to store the desired information and that can be accessed by network backup device 10. Communication media typically embodies processor readable instructions, data structures, program modules, or other data in a modulated data signal, such as a carrier wave or other transport medium and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Thus, for example, in some embodiments, the software modules illustrated in and described in connection with FIG. 2 may not be stored in network backup device 10, but rather communicated to network backup device 10 via any of these media. Computer readable media may also include combinations of any of the media described above.

FIG. 2 shows network backup device 10 in more detail. In one embodiment, network backup device 10 is implemented as a stand-alone backup appliance. When a client device 14, such as workstation 14A or laptop computer 14B of FIG. 1, has data to be backed up, it shares the data onto the network using a file sharing protocol native to the operating system of client device 14. The particular file sharing protocol used varies according to the type of client device 14. For example, a client device 14 running on the MICROSOFT WINDOWS® operating system shares the data onto the network using the CIFS protocol. Other client devices may use the NFS protocol, the AppleTalk protocol, or any other file sharing protocol native to the particular client device.

In the CIFS protocol, client device 14 shares data by transmitting a message to network backup device 10 using, for example, the Server Message Block (SMB) protocol to connect to network backup device 10. After establishing a connection, network backup device 10 can use the file sharing protocol to query and browse the file system of client device 14 and locate the data to be backed up. For example, network backup device 10 may request certain files or directories that it is scheduled to back up by transmitting information identifying the requested files or directories.

Network backup device 10 uses the file sharing protocol to retrieve the data from client device 14. More particularly, a backup module 32 transmits a request for the data to client device 14, which responds by transmitting the requested data to network backup device 10. One or more data access modules 33 receive the data using file sharing protocols native to an operating system of client device 14. Backup module 32 then stores the received data using software that provides backup and restore capabilities. Backup module 32 runs on an operating system 34, such as the UNIX operating system or the LINUX operating system, which typically includes the file sharing protocols, along with other software, e.g., software for querying source systems using non-native file sharing protocols. For example, the UNIX and LINUX operating systems usually use the NFS protocol for file sharing. These operating systems typically do not use the CIFS protocol for most file sharing operations; therefore, the CIFS protocol is considered non-native to the UNIX and LINUX operating systems. A network backup device 10 that uses the UNIX operating system or the LINUX operating system may access the CIFS file sharing protocol via the publicly available SAMBA software suite or similar software. Operating system 34 also provides access to scheduling capabilities and driver-level interfaces to attached devices.

As backup module 32 receives the data from client device 14, backup module 32 backs up the data to data disks 36. Data disks 36 are offline in that, while present on the network, they are not visible to client device 14 or to other devices on the network and are not accessible for general use as storage devices. A redundant array of independent disks (RAID) software module 38 may use conventional RAID striping techniques to store backup data across multiple data disks 36, improving speed for both reading and writing the backup data. Alternatively, the multiple data disks 36 may be managed as a single logical volume 40. As data disks 36 become populated with data, backup module 32 may archive backup data from data disks 36 to a tape-based storage device 40.

In one embodiment, a user interface 44 presents a web-based management interface that allows users to access backup device 10 via the Internet to perform day-to-day management of backup device 10. By interacting with user interface 44, a user can coordinate backup and restore operations, manage system settings, and advise users of the status of backup device 10 and of backup and restore operations. For example, the user can maintain a backup schedule that specifies intervals at which data is to be backed up. A scheduling module 46 initiates backup operations based on this backup schedule. Users can also perform other management tasks, such as installing devices, reconfiguring the network address and local name servers, modifying security parameters, and verifying that the data found by the file sharing protocols actually requires backup. User interface 44 obviates the need to use a remote login session to access backup device 10 and to manage individual software components once logged in, thereby making the task of managing backup device 10 relatively simple.

User interface 44 may be implemented using commercially available web server software, such as APACHE web server software. If user interface 44 fails, backup device 10 can be managed using alternative interfaces, such as via a Telnet session. A management layer 47 lies under user interface 44 and interacts with operating system 34 to manage data and operations. Management layer 47 may be implemented using, for example, a Java servlet model.

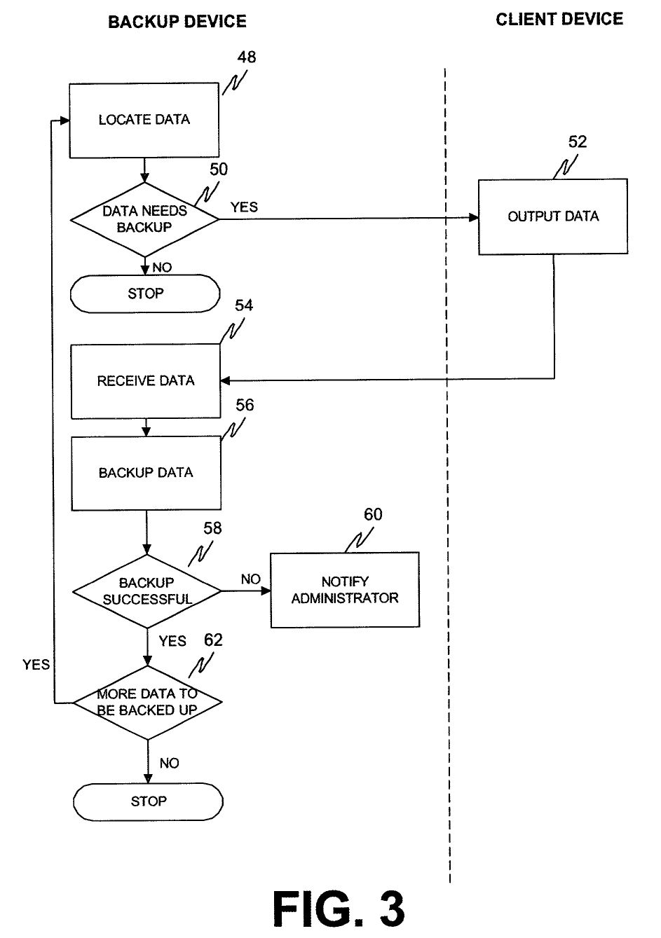

FIG. 3 is a flow diagram illustrating an example mode of operation for backing up data on a network, according to an embodiment of the invention. The data to be backed up includes shared files or directories on the file system of the client device. These shared files can be accessed by other devices connected to the network, including a backup appliance, using a file sharing protocol native to the operating system of the client device. The file sharing protocol may be native or non-native to the operating system of the backup device. If the file sharing protocol is non-native to the operating system of the backup device, the backup device may use a software suite to access the file sharing protocol, as described above in connection with FIG. 2.

As dictated by a backup schedule, a scheduler initiates a backup operation of one or more files or directories. The backup device locates data to be backed up, as specified in the backup schedule, using the file sharing protocol to access the shared files or directories on the client device (48). After locating the data, the backup appliance determines whether the data needs to be backed up (50), for example, by comparing time stamps, file sizes, or both. In some cases, the data may already have been backed up, and as a result may not need to be backed up again. If the data does need to be backed up, the backup appliance requests the data from the client device, which outputs the data on the network (52). The backup appliance receives the data (52) and determines whether the data actually needs to be backed up (54), for example, by comparing time stamps or file sizes, or both. In some cases, the data may already have been backed up, or may not have been changed since the most recent backup, and as a result may not need to be backed up again.

The network backup appliance receives the data (54) and, if needed, backs up the data to its local disk drives (56). In one embodiment, the network backup device uses the CIFS file sharing protocol to back up the data on a share level, i.e., backing up all files in the base directory and nested directories from the share point. For example, if the share point is located at the root directory of the client device, the network backup device would back up all of the files in the root directory and all of the subdirectories located beneath the root directory in the file system—in this case, the entire directory structure.

The network backup device uses a back up procedure appropriate for the file sharing protocol used to locate the files or directories to be backed up. For example, in the CIFS file sharing protocol, the network backup device uses an FTP-like client to copy individual files from the client device. By contrast, in the NFS protocol, the network backup device mounts the client device, such that the client device appears as part of the file system of the backup device. The backup device then uses local tools to back up the data.

Backups can be performed either as full backups or as incremental backups, with various levels of incremental backup possible based on the backup technique used. Subsequent restore operations can be performed either on an individual file basis or on a directory basis. The network backup device can restore data either to the share that originated the data or to an intermediate location. The manner in which the backup and restore operations are performed can be controlled via the management user interface.

As each file or directory is backed up, the backup device determines whether the backup is successful (58) and, if unsuccessful, logs the files and directories that it could not back up and notifies the administrator (60). The administrator may then retry the backup of these files and directories, possibly at regular intervals until successful, as specified when the administrator configures the backup operation. If the backup is successful, the backup device determines whether it should backup any more data (62), e.g., another file or directory from the file system of the client device. If so, the backup device locates the additional data to be backed up (48), and the process repeats until the backup device is finished backing up data. As the local disk drives are populated, backup data may be archived to a secondary device, such as a tape backup device. The secondary device may be connected to the network backup device using a SCSI connection.

A number of implementations and embodiments of the invention have been described. Nevertheless, it is understood that various modifications can be made without departing from the spirit and scope of the invention. Accordingly, these and other embodiments are within the scope of the following claims.

1. A network backup device comprising:
an interface module to receive a backup schedule from a user;
a scheduling module to determine whether to back up data from shared storage areas of devices within a network based on the schedule;
a set of data access modules to access data using file sharing protocols native to operating systems of the network devices; and
a backup module to store the data to a storage medium.

2. The network backup device of claim 1, wherein the set of data access modules comprises data access modules to receive data using at least one of the Common Internet File System (CIFS), the Network File System (NFS), and the AppleTalk file sharing protocols.

3. The network backup device of claim 1, wherein the storage medium comprises a plurality of disk drives arranged as a single logical volume.

4. A network backup device comprising:
a data sharing module to access data stored on a network device using a file sharing protocol native to an operating system of the network device; and
a storage medium to back up the accessed data.

5. The network backup device of claim 4, wherein the network device comprises a networked file server having a shared storage area to store the data.

6. The backup device of claim 4, wherein the storage medium comprises a plurality of disk drives arranged as a single logical volume.

7. The backup device of claim 4, wherein the file sharing protocol is selected from the group consisting of the Common Internet File System (CIFS), the Network File System (NFS), and the AppleTalk file sharing protocols.

8. A network backup system comprising:
a data sharing module to access data from a network device using a file sharing protocol native to an operating system of the network device;
a plurality of disk drives to back up the accessed data; and
a tape-based medium to archive data from the plurality of disk drives.

9. The backup arrangement of claim 8, wherein the file sharing protocol is selected from the group consisting of the Common Internet File System (CIFS), the Network File System (NFS), and the AppleTalk file sharing protocols.

10. The backup arrangement of claim 8, wherein the plurality of disk drives are arranged as a single logical volume.

11. A backup method comprising:
accessing data from a network device using a file sharing protocol native to an operating system of the network device; and
storing the accessed data using a storage medium.

12. The method of claim 11, further comprising archiving data from the storage medium.

13. The method of claim 11, wherein the file sharing protocol is selected from the group consisting of the Common Internet File System (CIFS), the Network File System (NFS), and the AppleTalk file sharing protocols.

14. The method of claim 11, further comprising determining whether the received data requires backup.

15. The method of claim 11, further comprising issuing a notification when the received data cannot be stored.

16. A computer-readable medium containing computer-executable instructions for:
accessing data from a network device using a file sharing protocol native to an operating system of the network device; and
storing the accessed data using a storage medium.

17. The computer-readable medium of claim 16, containing further computer-executable instructions for archiving data from the storage medium.

18. The computer-readable medium of claim 16, wherein the file sharing protocol is selected from the group consisting of the Common Internet File System (CIFS), the Network File System (NFS), and the AppleTalk file sharing protocols.

19. The computer-readable medium of claim 16, containing further computer-executable instructions for determining whether the received data requires backup.

20. The computer-readable medium of claim 16, containing further computer-executable instructions for issuing a notification when the received data cannot be stored.

21. A method for restoring data stored on a backup device connected to a network, the method comprising:
outputting the data using a file sharing protocol native to an operating system of the backup device; and
storing the data using a network device connected to the network.

22. The method of claim 21, wherein the network device is an originator of the data.

23. The method of claim 21, wherein the file sharing protocol is selected from the group consisting of the Common Internet File System (CIFS), the Network File System (NFS), and the AppleTalk file sharing protocols.

24. The method of claim 21, wherein the data represents at least one file.

25. The method of claim 21, wherein the data represents at least one directory.

26. A computer-readable medium containing computer-executable instructions for:
outputting data stored on a backup device connected to a network using a file sharing protocol native to an operating system of the backup device; and
storing the data using a network device connected to the network.

27. The computer-readable medium of claim 26, wherein the network device is an originator of the data.

28. The computer-readable medium of claim 26, wherein the file sharing protocol is selected from the group consisting of the Common Internet File System (CIFS), the Network File System (NFS), and the AppleTalk file sharing protocols.

29. The computer-readable medium of claim 26, wherein the data represents at least one file.

30. The computer-readable medium of claim 26, wherein the data represents at least one directory.

31. A backup device comprising:
a scheduling module to initiate a backup operation according to a backup schedule; and
a backup module to access shared data from a device in communication with a network and to store the accessed data using an offline storage medium.

32. The backup device of claim 31, wherein the backup module is configured to access the shared data using a file sharing protocol native to an operating system of the device in communication with the network.

33. The backup device of claim 32, wherein the file sharing protocol is selected from the group consisting of the Common Internet File System (CIFS), the Network File System (NFS), and the AppleTalk file sharing protocols.
